(19) United States
(12) Patent Application Publication
(10) Pub. No.: US 2012/0244509 A1
(43) Pub. Date: Sep. 27, 2012

(54) CHILD ASSESSMENT SYSTEM AND METHOD

(75) Inventors: Catherine Curtis Heroman, Baton Rouge, LA (US); Toni S. Bickart, Washington, DC (US)

(73) Assignee: Teaching Strategies, Inc., Bethesda, MD (US)

(21) Appl. No.: 13/071,234

(22) Filed: Mar. 24, 2011

(51) Int. Cl. G09B 7/00

(52) U.S. Cl. 434/362

(57) ABSTRACT

Methods, systems and computer program products for assessing a child using observational assessment data, and comparing the child to a predetermined target band for given age ranges.

### TECHNICAL FIELD

The invention relates to methods and systems for compiling, analyzing and reporting child development data.

### BACKGROUND OF THE INVENTION

Historically, assessments of children's skills have been based primarily on formal measures such as standardized tests. These tests usually require the child to respond to a series of requests in a certain amount of time. Young children usually do not perform well on such formal, standardized tests. These measures, therefore, are unreliable and do not fully capture and quickly convey a child's development. Children's development at a young age is predictable, but not rigid. It is overlapping and changes at an uneven rate. What is needed is a system that reflects the characteristics of child development and provides accurate assessments and comparisons based on children's performance over time in real-world situations. The system needs to provide guidance on where the child stands with respect to other children of his or her age, and visually demonstrate the progress the child is making.

### SUMMARY OF THE INVENTION

One embodiment of the present invention is a method for evaluating a child with a computer implemented system. The method includes using observational assessment data on a first child to assign a level to a first dimension in a first objective for the child, and then repeating the assigning of levels for additional dimensions in the first objective for the child. The method further includes scaling each of the levels based on predetermined weighting criteria in the system to achieve a scaled value for each dimension, and then compiling the scaled value for each dimension in the first objective to achieve a recommended objective assessment value for the first objective. The system is then used to compare the recommended objective assessment value to a predetermined target band stored in the database to assess the child in the first objective.

The present invention also relates to a computer implemented system for practicing the methods of the present invention. The system includes a secure database for storing information related to a child and program code for carrying out the operations of the method.

The present invention also relates to a computer program product including a computer storage medium having program logic stored thereon. The program logic includes machine readable code executable by a computer that can be used to practice the methods of the present invention.

The foregoing and other objectives of the invention will be more specifically discussed below.

### BRIEF DESCRIPTION OF THE DRAWINGS

For the purpose of illustrating the invention there is shown in the drawings various forms which are presently preferred; it being understood, however, that this invention is not limited to the precise steps, arrangements and instrumentalities particularly shown.

FIG. 1 is a figure showing the hierarchal nature of an embodiment of the present invention.

FIG. 2 is a figure showing target bands of an embodiment of the present invention.

FIG. 3 is a figure showing checkpoints of an embodiment of the present invention.

FIG. 4 is a figure showing a display of an embodiment of the present invention where the checkpoints are sorted by area for a class.

FIG. 5 is a figure showing a display of an embodiment of the present invention providing a snapshot of a child with respect to an area.

FIG. 6 is an example Performance and Growth Report of the present invention.

FIG. 7 is an example of a Widely Held Expectations Report of the present invention.

FIG. 8 is an example of a Class Profile Report of the present invention.

FIG. 9 is an example of a Child Profile Report of the present invention.

FIG. 10 is an example of a Development and Learning Report of the present invention.

FIG. 11 is an example of a Snapshot Report of the present invention.

### DETAILED DESCRIPTION OF THE DRAWINGS

For the purpose of illustrating the invention there is shown in the drawings various forms which are presently preferred; it being understood, however, that this invention is not limited to the precise arrangements and instrumentalities particularly shown.

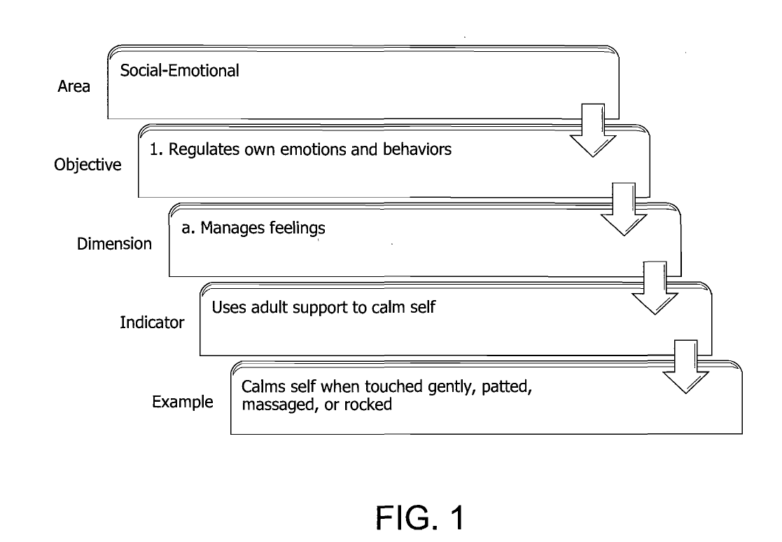

FIG. 1 shows a subset of a method for assessing a child's skills, knowledge and behavior, i.e., where a child stands with respect to one or more areas of development and learning. Children skills with respect to development, learning, and behavior are preferably assessed from birth to about 120 months and more preferably from birth to about 72 months. Preferably, the age bands have a duration of about between 1 month and 2 years. More preferably, the extent of the age bands are between about 6 months to about 18 months. Most preferably, the age bands are about 12 months.

Areas of development and learning can include major areas of child growth and development and major areas of content learning. The growth and development areas can include social-emotional, physical, language, and cognitive. The range of skills focused on can be dependent on the age of the child. The social-emotional area for one age range can focus on, for example, assessing a child's ability to learn about self and others. The social-emotional area for another age range can focus on, for example, evaluating a child's sense of self, a child's responsibility for self and others, and a child's prosocial behavior. The physical area for one age range can focus on, for example, a child's learning to jump. The physical area for another age range can focus on, for example, balancing and a child's fine motor skills. The language area for one age range can focus on, for example, a child's ability show interest in the speech of others. The language area for another age range can focus on, for example, following detailed directions. The cognitive area for one age range can focus on, for example, a child's ability to learn and process information. The cognitive area for another age range can focus on, for example, a child's learning and problem solving, a child's logical thinking, and a child's representation and symbolic thinking.

The content learning areas can include literacy, mathematics, science and technology, social studies, and the arts. It is within the scope of this invention for the areas for development and learning to include more than just the nine areas noted above. For example, areas of development and learning can also include English language acquisition.

The areas of development and learning can be assessed based on “developmental assessment data,” which as used herein, is information used to assess a child in a particular task, skill, function, trait, characteristic, ability, and the like. The developmental assessment data is primarily gathered through observation, and other similar subjective or semi-subjective means. The observations can take place in authentic everyday situations. As used herein, data collected in these manners is termed “observational assessment data.” Some (i.e., a minority) of the developmental assessment data can be gathered through testing and other objective means, but in the present invention, preferably the data is primarily data obtained by observation. Generally, the developmental assessment data is a compilation of subjective or semi-subjective findings based on objective or semi-objective standards. Preferably, the developmental assessment data are valid, reliable findings made by or monitored by one or more persons.

Developmental assessment data can be collected in a number of ways. For example, education assessment instruments can be used to collect the data. Education assessment instruments are tools used to assess the level of knowledge, ability, skill, and so on of a child. Primarily, education assessment instruments include a compilation of various subjective observations made by a care giver. As used herein, “care giver” includes teachers, parents, physical therapists, occupational therapists, speech therapists, case managers, psychiatrists, psychologists, counselors, doctors, nurses, and so on. The subjective observations are preferable when based on objective or semi-objective standards.

To acquire the developmental assessment data, a child is preferably assessed by one or more care givers across a variety of areas. To aid in the assessments, each area can include objectives that further refine what the area is looking to measure. Each objective can be broken down into dimensions. Each dimension can be broken down into indicators. Under each indicator there can be examples. The indicators and examples are preferably based on standard developmental and learning expectations for various age-groups and for classes or grades. With each step in the refinement, the issue being observed becomes more and more focused.

The Social-Emotional area can be broken down into objectives and dimensions as shown in Table 1.

TABLE 1
Area: Social-Emotional

| Objective | Regulates own emotions and behaviors | |
|---|---|---|
| | Dimension | Manages feelings |
| | Dimension | Follows limits and expectations |
| | Dimension | Takes care of own needs appropriately |
| Objective | Establishes and sustains positive relationships | |
| | Dimension | Forms relationships with adults |
| | Dimension | Responds to emotional cues |
| | Dimension | Interacts with peers |
| | Dimension | Makes friends |
| Objective | Participates cooperatively and constructively in group | |
| | situations | |
| | Dimension | Balances needs and rights of self and others |
| | Dimension | Solves social problems |

The Physical area can be broken down into objectives and dimensions as shown in Table 2.

TABLE 2
Area: Physical

| | |
|---|---|
| Objective | Demonstrates traveling skills |
| Objective | Demonstrates balancing skills |
| Objective | Demonstrates gross-motor manipulative skills |
| Objective | Demonstrates fine-motor strength and coordination |

| | |
|---|---|
| Dimension | Uses fingers and hands |
| Dimension | Uses writing and drawing tools |

The Language area can be broken down into objectives and dimensions as shown in Table 3.

TABLE 3
Area: Language

| Objective | Listens to and understands increasingly complex language | |
|---|---|---|
| | Dimension | Comprehends language |
| | Dimension | Follows directions |
| Objective | Uses language to express thoughts and needs | |
| | Dimension | Uses an expanding expressive vocabulary |
| | Dimension | Speaks clearly |
| | Dimension | Uses conventional grammar |
| | Dimension | Tells about another time or place |
| Objective | Uses appropriate conversational and other communication | |
| | skills | |
| | Dimension | Engages in conversations |
| | Dimension | Uses social rules of language |

The Cognitive area can be broken down into objectives and dimensions as shown in Table 4.

TABLE 4
Area: Cognitive

| Objective | Demonstrates positive approaches to learning | |
|---|---|---|
| | Dimension | Attends and engages |
| | Dimension | Persists |
| | Dimension | Solves problems |
| | Dimension | Shows curiosity and motivation |
| | Dimension | Shows flexibility and inventiveness in thinking |
| Objective | Remembers and connects experiences | |
| | Dimension | Recognizes and recalls |
| | Dimension | Makes connections |
| Objective | Uses classification skills | |
| Objective | Uses symbols and images to represent something not present | |
| | Dimension | Thinks symbolically |
| | Dimension | Engages in sociodramatic play |

The Literacy area can be broken down into objectives and dimensions as shown in Table 5.

TABLE 5
Area: Literacy

| Objective | Demonstrates phonological awareness | |
|---|---|---|
| | Dimension | Notices and discriminates rhyme |
| | Dimension | Notices and discriminates alliteration |
| | Dimension | Notices and discriminates smaller and smaller |
| | | units of sound |
| Objective | Dimonstrates knowledge of the alphabet | |
| | Dimension | Identifies and names letters |
| | Dimension | Uses letter-sound knowledge |
| Objective | Demonstrates knowledge of print and its uses | |
| | Dimension | Uses and appreciates books |
| | Dimension | Uses print concepts |
| Objective | Comprehends and responds to books and other texts | |
| | Dimension | Interacts during read-alouds and book |
| | | conversations |
| | Dimension | Uses emergent reading skills |
| | Dimension | Retells stories |
| Objective | Demonstrates emergent writing skills | |
| | Dimension | Writes name |
| | Dimension | Writes to convey meaning |

The Mathematics area can be broken down into objectives and dimensions as shown in Table 6.

TABLE 6
Area: Mathematics

| | |
|---|---|
| Objective | Uses number concepts and operations |

| | |
|---|---|
| Dimension | Counts |
| Dimension | Quantifies |
| Dimension | Connects numerals with their quantities |

| | |
|---|---|
| Objective | Explores and describes spatial relationships and shapes |

| | |
|---|---|
| Dimension | Understands spatial relationships |
| Dimension | Understands shapes |

| | |
|---|---|
| Objective | Compares and measures |
| Objective | Demonstrates knowledge of patterns |

The Science and Technology area can be broken down into objectives as shown in Table 7.

TABLE 7
Area: Science and Technology

| | |
|---|---|
| Objective | Uses scientific inquiry skills |
| Objective | Demonstrates knowledge of the characteristics of living things |
| Objective | Demonstrates knowledge of the physical properties of objects |
| | and materials |
| Objective | Demonstrates knowledge of Earth's environment |
| Objective | Uses tools and other technology to perform tasks |

The Social Studies area can be broken down into objectives as shown in Table 8.

TABLE 8
Area: Social Studies

| | |
|---|---|
| Objective | Demonstrates knowledge about self |
| Objective | Shows basic understanding of people and how they live |
| Objective | Explores change related to familiar people or places |
| Objective | Demonstrates simple geographic knowledge |

The Arts area can be broken down into objectives as shown in Table 9.

TABLE 9
Area: The Arts

| | |
|---|---|
| Objective | Explores the visual arts |
| Objective | Explores musical concepts and expression |
| Objective | Explores dance and movement concepts |
| Objective | Explores drama through actions and language |

The English Language Acquisition area can be broken down into objectives as shown in Table 10.

TABLE 10
Area: English Language Acquisition

| | |
|---|---|
| Objective | Demonstrates progress in listening to and understanding |
| | English |
| Objective | Demonstrates progress in speaking English |

FIG. 1 demonstrates the hierarchal nature of an embodiment of the assessment system. At the highest level there is the area, which in this example is Social-Emotional. At the next level down there is an objective, which in this example is “Regulates own emotions and behaviors.” At the next level down there is a dimension, which in this example is “Manages feelings.” At the next level down there is a indicator, which in this example is “Uses adult support to calm down.” Finally, there is an example under the indicator, the example stating “Calms self when touched gently, patted, massaged, or rocked.”

The hierarchal system provides the care giver with guidance on how to assess a child's skills. Instead of trying to adequately assess a child's skills, let alone the skills of a classroom full of children, on a broad area such as “Social-Emotional” or even a slightly narrower, but still broad objective of “Regulates own emotions and behaviors,” the care giver can focus on specific indictors. In this case, does the child use adult support to calm him or herself, e.g., does the child calm him or herself when touched gently, patted, massaged or rocked. This question is a lot easier to answer than the more general question of does the child regulate his or her own emotions and behaviors. Because the system is primarily based on observational assessment data, the more refined the assessment measures, the more accurate the assessment will be.

FIG. 1 demonstrates a simple example of the hierarchal system. The present system, however, can provide for a more complex system with multiple objectives under each area, multiple dimensions under each objective, multiple indicators under each dimension, and multiple examples under each indicator. For example, a given area can have 3 objectives under it, each objective can have 3 dimensions under it, and each dimension can have 3 indicators under it. The system allows the information for each indicator to be rolled up into its associated dimension, which in turn can be rolled up into its associated objective, which in turn can be rolled up into its associated area. The result is that an individual can view the assessment with a child at the area level down to the indicator level, and every level in between. In the above example, that would mean that the assessment at the area level would be based on 27 indicators (3 objectives in the area×3 dimensions in each objective×3 indicators in each dimension). The assessment at the objective level would be based on 9 indicators (3 dimensions each objective×3 indicators in each dimension). The assessment at the dimension level would be based on 3 indicators (3 indicators in each dimension).

The number of components in each level in the example above are merely for exemplary purposes. It is contemplated that there can be any number of objectives in each area, any number of dimensions in each objective, any number of indicators in each dimension, and any number of examples in each indicator. For example, there can be 1 to 10 objectives per area, 2 to 8 objectives per area, 3 to 7 objectives per area, or 4 to 6 objectives per area. There can be 1 to 10 dimensions per objective, 2 to 8 dimensions per objective, 3 to 7 dimensions per objective, or 4 to 6 dimensions per objective. There can be 1 to 10 indicators per dimension, 2 to 8 indicators per dimension, 3 to 7 indicators per dimension, or 4 to 6 indicators per dimension.

In practice, for each observation, a care giver enters a preliminary assessment “level” into a relevant dimension or, if more than one dimension applies, into multiple dimensions. The preliminary level assignment can be, but does not have to be the final checkpoint decision. The checkpoint decision can be made at the end of the checkpoint period after reviewing all of the documentation. As used herein, “checkpoint decision” means an assessment made at the end of a “checkpoint period,” which is predefined period of time such as a marking period, semester, month, and the like. For example, in a 10 month program there can be three checkpoint periods, while in a 12 month program there can be four checkpoint periods.

How the level is assessed depends on the dimension. For some dimensions, the level may be assessed as a simply yes or no answer to an indicator, e.g., does the child recognizes and names a few numerals. Other dimensions may be more complex. For example, Table 11 below shows the assessment level for Area: Literacy, Objective: Comprehends and responds to books and other texts, Dimension: Retells stories.

TABLE 11

| Level | Indicators |
|---|---|
| Not yet | Not yet |
| Level 1 | |
| Level 2 | Retells some events from familiar story with close adult |
| | prompting |
| Level 3 | |
| Level 4 | Retells familiar stories, using pictures or props as prompts |
| Level 5 | |
| Level 6 | Retells a familiar story in proper sequence, including major |
| | events and characters |
| Level 7 | |
| Level 8 | Retells stories with many details about characters, events and |
| | storylines |
| Level 9 | |

In this example, if a child can retell some events for a familiar story, but only does so with close adult prompting, then the child would be considered to be in level 2. If the child can retell a familiar story with pictures or props as prompts, then the child would be considered to be in level 4. This example demonstrates that multiple observations of the child increase the accuracy of the assessment as the child, even though having the ability to do so, may not be interested in retelling a story on any given day.

While the hierarchal nature of the system focuses the care giver's assessment of a child's skills, the system of the present invention provides additional guidance to the care giver in the form of target bands indicating the age or the class/grade range for widely held developmental or learning expectations. The target bands preferably are stored on a database in the system. The target bands can be associated with an objective or with an area, and provide the care giver guidance on whether the child is falling within developmental or learning expectations for a particular objective or area.

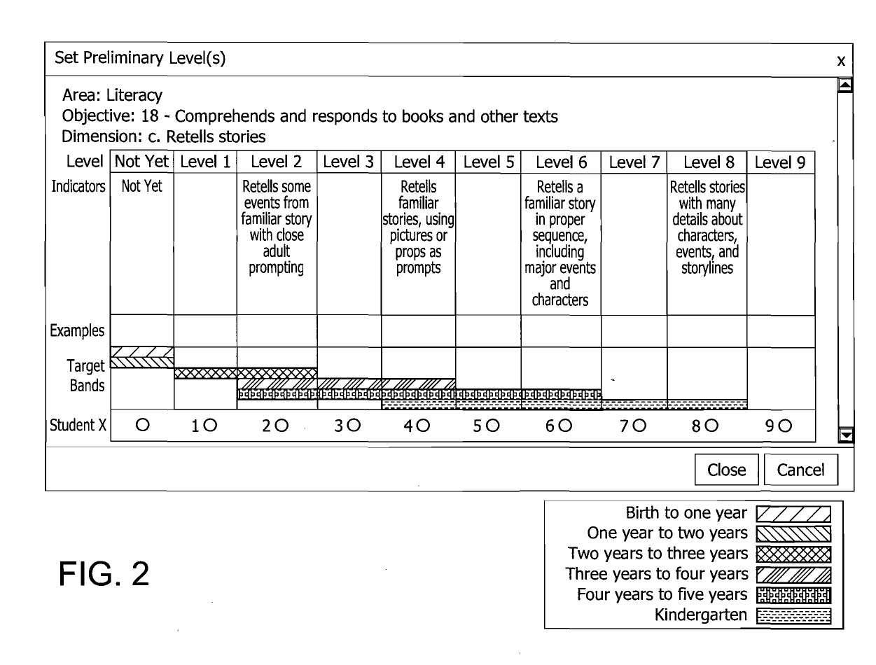

FIG. 2 shows the target bands for the same area, objective, dimension, level and indictors noted in Table 1 above. As can be seen from FIG. 2, a child from birth to one year, and a child from one year to two year are not expected to “Retell Stories.” From age two to three, a child is expected to be in level 1 or 2 of the dimension, with level 2. From age three to four, a child is expected to be in level 2 to level 4. From age four to five, a child is expected to be in level 2 to level 6. When the child is of kindergarten age, the child is expected to be in level 4 to level 8.

The target bands provide a context to the care giver's assessment of the child's skills, and can provide an early indication to the care giver that the child is lacking in a particular dimension. This early indication allows the care giver to alter his or her education of the child and/or seek additional resources to provide early intervention to address any issues.

The target bands can be set, preferably for each dimension, objective or area, by determining a scaled score that represents the desired percentile cutoff (e.g., 9.68^{th} percentile) for each age within a given target band (e.g., birth to one year, one to two year, two to three years, three to four years, four to five years, and kindergarten). This can be done by estimating fixed effects regression models (one for each dimension, objective, or area) of scaled scores from a representative sample using age and age-squared as predictors. Using the results from the model, the expected value for each time period of time in the target band (e.g., one year) can be determined. Then, using the standard deviation from the model, the desired target bands can be determined. While the target bands in FIG. 2 are shown with respect to one year increments, other increments may be used (e.g., monthly, quarterly, semi-annually).

The target bands are preferably based on a thorough review of research and child development literature in which developmental milestones and learning trajectories have been documented. As new research emerges in the field, the target bands can be adjusted.

Colors or another visual representation can be used on the target bands to distinguish one age or class/grade ranges from another. Red, orange, and yellow can code each year of life for the first 3 years, and green, blue, and purple can code classes/grades for the next 3 years. Those colors or other visual representations can be imported into one or more reports to allow the care giver to see how a child, class or children, a group of children, etc. are progressing with respect to widely held expectations.

The target bands provide a visual representation of widely held expectations for development and learning and show where most children of a particular age-group or class/grade are likely to be at the beginning and end of a program year with respect to a particular area, objective, dimension, etc. In one embodiment, care givers assessing skills of children in the first 3 years should adjust their expectations based on the child's age. In the next 3 years, there are more standard expectations for each year in group programs. For example, a teacher with a preschool class designed for 3-year-olds would first focus on the indicators for a 3 to 4 year old and consider the children's skills, knowledge, and behavior in comparison to those expectations. This would be so even if a few of the children in the group are a few months shy of age 3 in September or turning 4 during the program year. Then, if those indicators do not describe a particular child's skills, knowledge, and behavior, the teacher would look to the indicators of other target bands for guidance. A teacher with a pre-K 4 class designed for 4- to 5-year-olds would first focus on the 4 to 5 year old indicators. A kindergarten teacher would instruct and assess with the kindergarten target band in mind, whether the children are 4, 5, or 6 years old.

In the system of the invention, each child is assigned to a particular target band. The way the child is assigned preferably is dependent on the age or level of the child. For infants, toddlers, and twos (birth to 36 months), the child is preferably added to a group based on age. For example, a 10-month-old child is assigned to Birth to 1 year olds (a first target band). When she turns 2 in November, she is updated to 1 to 2 year olds (a second target band). Thus, the assigned group for a child under the age of 3 might change during the course of a year based on the child's birth date.

For preschool, pre-kindergarten, and kindergarten (children age 3 and older), the child preferably is first assigned to a class type that can be designated as Preschool, Pre-K, K and older grades. A care giver can then assign each child into a class/grade. The care giver can choose to assign the child to 3 to 4 year olds (preschool 3), 4 to 5 year olds (pre-k 4 class), or Kindergarten. The class/grade for the children in the Preschool, Pre-K, K classes is not based on the child's birth date, but on the class/grade assigned by the care giver or the administration for the entire school year. That's because children typically remain in the same group with the same care giver for the year.

Even if the child is technically a few months shy of the age level (or a year or two above the age level in the case of a child with developmental delays) the child is in the “class/grade” and her skills are assessed at the target band of the expectations for that year. If the child's skills do not meet expectations for that target band, the reason may be obvious—she's a bit young for the grade and we don't worry if she needs more time. Or, in the case of a child with delays, it is a good way to show she is making progress. In a Kindergarten class, children are held to the expectations of the Kindergarten target band whether they are 4-, 5-, or 6-years-old.

In most programs, all children in a Class will have the same Age or Class/Grade, but the ability to assign the Age or Class/Grade for each child allows programs to have classes with mixed ages.

The care giver can enter a preliminary level by clicking one of the radio buttons shown in FIG. 2, the radio buttons being associated with which level the care giver believes the child has achieved. At a final checkpoint, the care giver can then revise that assessment or can keep the assessment the same. While FIG. 2 shows a radio buttons for entering the assessed level, other means are also contemplated. For example, the system can include drop down menus for selecting the level or the system can allow for manual entry of the level.

Preferably, the care givers observe and/or assess the child on more than one dimension in one or more areas and identify the level in which the child falls for that particular dimension. A score can then be associated with the designated level. Different systems can be used to assess the child. For example, a child's skills, knowledge, and behavior can be described as Level 1, Level 2, Level 3, Level 4, Level 5, Level 6, Level 7, Level 8, or Level 9 for a particular dimension. Scores can then be established for each dimension based the stage of development of the child. For example, if a child is at Level 1 for the dimension A, the child would receive a score of 1 for objective A.

When a care giver assesses a child's skills in order to select the level that best describes the skills related to the objectives and dimensions, the care giver preferably selects a level based on documentation of what a child knows and can do—his skills, knowledge, and behaviors—regardless of the Age or Class/Grade to which the child has been assigned. In that way the care giver is able to see whether a child's skills are below, meeting, or exceeding expectations.

Once levels are entered in each dimension in a particular objective, the system can recommend a level for that objective. The recommendation can be carried out by way of an algorithm, a factor analysis, calculation protocol, weighting adjustment or other similar analysis on the data to determine scores for each of the children in each of the areas. The algorithm or other analysis preferably identifies which dimensions are associated with each of the objectives or areas and weights the dimensions in accordance with their importance to the particular objective or area (e.g., a dimension that is very important to development in objective A would be weighted higher than a dimension that is only moderately important to development in objective A). The algorithm or other analysis can also weight each of the dimensions depending on each of the children's responses to those dimensions. The result of the algorithm or other analysis is a scaled value for each dimension. The system can compile the scaled value for each dimension in a particular objective to produce a recommended objective assessment value for that objective, which is preferably displayed against the target band so that the care giver can compare the assessment with the target bands and thereby quickly and visually know the child's development as compared to the desired range for the child's level. After the recommended objective assessment value is produced, the care giver can then choose to follow that recommendation and enter the recommended level into the objective or area, or can enter there own level into the objective or area.

Alternatively, once raw scores are collected for each of the dimensions, the care givers' involvement in the method can end and subsequent steps of the method can be automated with a system of the present invention. The subsequent steps can include determining what dimensions are the best measure for each area and compiling the raw scores into area assessments accordingly. The compiled scores can be scaled to account for the differing levels of difficulty in progressing across the levels of the different dimensions. For example, progress on certain dimensions, or levels within a particular dimension, may be more difficult to achieve than it is on other dimensions, or levels with a particular dimension. The differences in difficulty should be accounted for when assessing the overall outcome for the area by, for example, weighting the dimensions, or the levels steps within a particular dimension. The weighting can be based on the difficulty of achieving a certain level or dimension, the importance of the level or dimension to excelling in a particular area, or some other similar factor.

Table 12 below shows a way of scoring for the Literacy Area for a child in the Pre-K category. As shown, the child's score for each of the objectives is the sum of the child's score for each dimension under that objective, which are shown in the parentheses. For example, for the Phonological Awareness Objective, the child received a score of 5 for the notices and discriminates rhyme dimension, a 3 for the notices and discriminates alliteration dimension, and a 3 for the notices and discriminates smaller and smaller units of sound dimension, for an objective total of 11. That score of 11 is compared against the range of widely held expectations for a pre-K child for that objective. The range is preferably calculated by summing the lowest level of widely held expectations for each dimension (4 for the notices and discriminates rhyme dimension, 3 for the notices and discriminates alliteration dimension, and 2 for the notices and discriminates smaller and smaller units of sound dimension) for the low end of the range, and the highest level of widely held expectations for each dimension (6 for the notices and discriminates rhyme dimension, 6 for the notices and discriminates alliteration dimension, and 5 for the notices and discriminates smaller and smaller units of sound dimension) for the high end of the range. While not shown in the table, the same process is repeated for the other objectives (i.e., Alphabet Knowledge, Print Concepts, Comprehension, and Writing). The child's score in each of the objectives are then added together to get a total score for the objective (41 in Table 12). That score is then compared to a range of widely held expectations for that objective. That range is calculated by summing the low end of the ranges for each of the objectives to get the low end of the range (9+4+7+8+6=34) and summing the high end of the range for each of the objectives to get the high end of the range (17+11+13+18+11=70).

TABLE 12

| | Widely Held Expectation | |
|---|---|---|
| Objective | Pre-K | Child's Score |
| Phonological Awareness | (4 + 3 + 2)-(6 + 6 + 5) | (5 + 3 + 3) |
| | 9-17 | 11 |
| Alphabet Knowledge | 4-11 | 4 |
| Print Concepts | 7-13 | 6 |
| Comprehension | 8-18 | 10 |
| Writing | 6-11 | 10 |
| Summary | 34-70 | 41 |

In the system of the present invention, the target bands, and all of the supporting data for the target bands are preferably stored in a first database. The observational assessment data for the child is then collected and modified (e.g., scaled based on weighing factors) in a second database (which may be a subset of the first database). The first database can be a secure database where only limited persons have access. Preferably, care givers do not have access to the first database. The second database, on the other hand, is preferably accessible by multiple parties including a database administrator, care givers, etc. Alternatively, the target bands, and if desired, the data supporting the target bands, can be stored in the same database as the observational assessment data for the child. In this alternative, the target bands are preferably secure, with only limited persons having access to them.

After an initial determination at a final checkpoint of whether a child falls within the appropriate target band, subsequent determinations can be made using the same approach at subsequent final checkpoints. A second determination can then be compared to the initial determination, a third determination can then be compared to the second determination, a fourth determination can then be compared to the third determination, and so on. Those comparisons allow the care giver to see the child's progress in knowledge, skills and behavior.

The system and the associated computer program product of the present invention provide for multiple data entry points, and multiple displays for viewing data and other information.

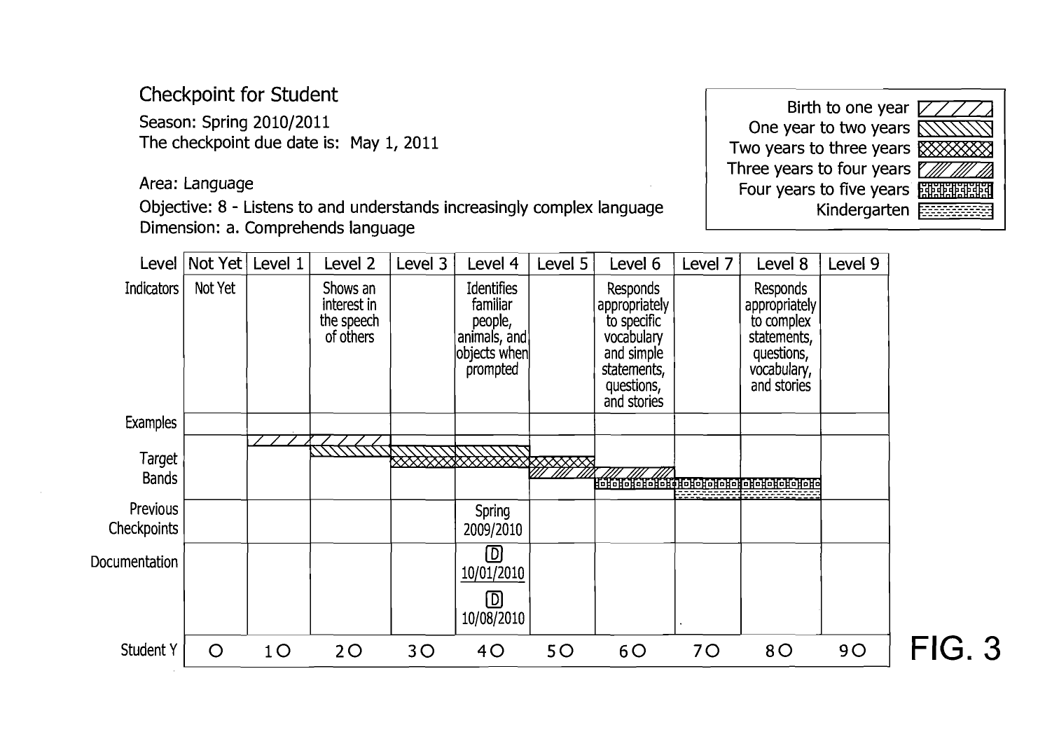

FIG. 3 shows a display screen, which can be converted to a report using a report module or simple by printing, where multiple checkpoints are present. The display in FIG. 3 shows information pertaining to a child for the following Area: Language, Objective: Listens to and understands increasingly complex language, Dimension: Comprehends language. The display also depicts the various levels in the dimension and includes the indicators that are associated with each of those levels. While the indicators and bands are shown in the display of FIG. 3, it is also contemplated that the system can include programming that permits a user to hide the information, such as a clickable button, or selected keystrokes). The display in FIG. 3 also includes the target bands for the dimension, showing the widely held developmental or learning expectations for this dimension for birth to one year, one to two year, two to three years, three to four years, four to five years, and kindergarten. As shown, the display may include previous checkpoints that have been entered, thus providing the user with visual depiction of the child's monitoring. The entries for the checkpoints can be linked to further information from the checkpoint entry. FIG. 3 also shows icons for various uploaded documentation, which the care giver can click to gain access to the documentation if the display is viewed on screen. Finally, FIG. 3 shows the radio buttons for each of the levels, which the care giver can select to associate a level for this dimension if the display is viewed on screen.

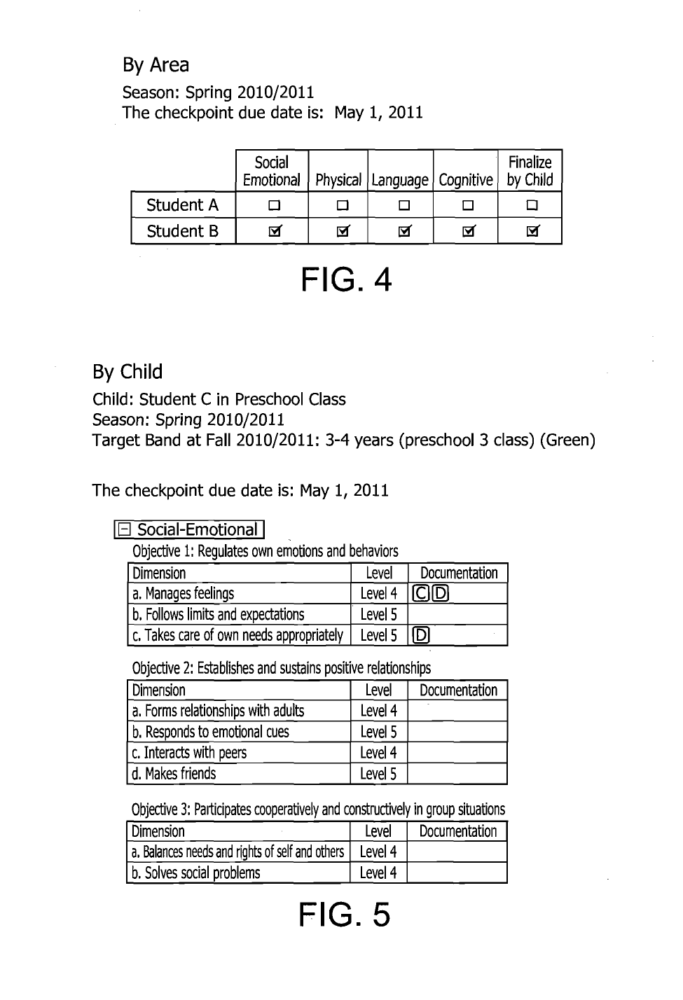

FIG. 4 shows a display, which can be converted to a report using a report module or simply by printing, where the checkpoints are organized by area for a class. The screen in FIG. 4 includes an identifier for the season or review period that the assessment relates to and when the next checkpoint is due. As shown in FIG. 4, the system preferably displays each child with check boxes or other identifiers for each area of assessment, thus providing a visual indication of whether the student has been assessed in a given area. As can be seen in the figure, Student A has yet to be assessed in any of the areas, while Student B has been assessed in all of the listed areas. This display allows a care giver to focus his or her assessments on the children and/or areas that need assessment.

FIG. 5 shows a display, which can be converted to a report using a report module or simple by printing, where the checkpoints are organized by child. As shown in FIG. 5, the system provides a visual depiction of where a student, such as Student C, stands with respect to objectives, which in the illustrated case are objectives in the Social-Emotional area. The system displays the target band associated with Student C for the given season/semester, and shows what level Student C has achieved for numerous dimensions. For example, FIG. 5 shows that for Objective: Regulates own emotions and behaviors, Student C is at Level 4 at the Dimension: Manages feelings. The care giver, if viewing this display on screen, can click on the Level 4 designation and be taken by hyperlink or other similar means to a display, like the ones shown in FIG. 2 or 3, that provides more details on the dimension and where the child falls in that dimension with respect to the target bands. As shown in FIG. 5, the system also preferably provides a listing of all dimensions having documentation associated with them. In the illustrated case, the Dimensions: Manages feelings and Takes care of own needs appropriately both include documentation. Again, if the care giver is viewing the display on screen, the care giver can click on the documentation icon and be taken by hyperlink or other similar means to an image of the actual documentation. The ability to display the information as shown in FIG. 5 allows a care giver to see if there are any areas where the child has not been assessed, is lagging in development, is advanced in development and so on.

Using the methods and systems of the present invention, a report on a child can be generated at any time based on observational assessment data entered on the dimensions relating to that child. Preferably, reports for a child are generated for each of the areas of development and learning at least three times a year at predetermined checkpoint times.

The report generation can be automated in a report module such that the methods and systems of the present invention transform developmental assessment data, primarily collected from observational assessments of care givers, into reports that show where a child stands on an objective or in an area with respect to other children within his or her age range.

The report module can generate a Performance and Growth Report, a Widely Held Expectations Report, a Class Profile Report, an Individual Child Report, a Development and Learning Report, and a Snapshot Report. The reports can be generated as PDF files, HTML files, Flash files, spreadsheet files or other similar file format.

The Performance and Growth Reports assist users to look at change over time across multiple checkpoint seasons. Preferably this report is created only with finalized checkpoint data. The Performance and Growth Reports aim to answer whether a child is or group of children are meeting end of year expectations (performance) and whether a child is or group of children are demonstrating progress toward meeting expectations (growth). The report can show performance and growth of children throughout the academic year at the program level, site level, or within classrooms.

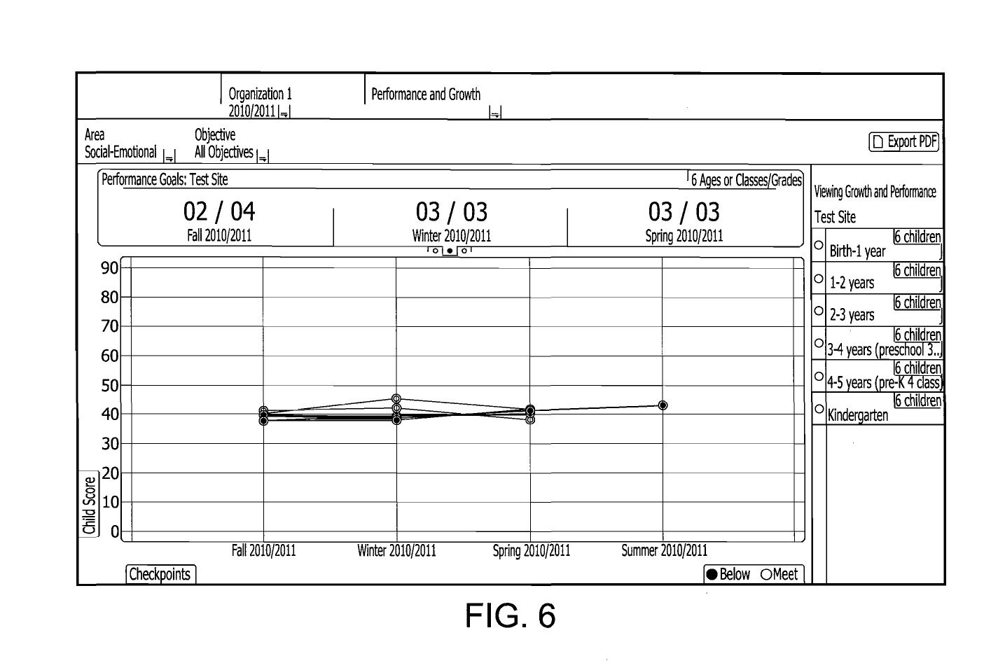

FIG. 6 is an example of a Performance and Growth Report. This report can chart and graphically show the progress of one or more children. FIG. 6 shows a report for 6 children in the 2 to 3 year old range, and charts their performance over three different checkpoints: Fall, Winter, and Spring. As shown, in the Fall 2 children were below expectations while 4 met expectations; in the Winter 3 children were below expectations while 3 met expectations; and in the Spring 3 children were below expectations while 3 were above expectations.

The Widely Held Expectations Reports enable users to compare information about the knowledge, skills, and behaviors of an individual child or groups of children with widely held expectations for children of the same age or grade/class. Preferably this report is created only with finalized checkpoint data. The report groups children into three categories: (1) Below—the numerical rating assigned to the child for a given objective or dimension is lower than those of the appropriate target band; (2) Meets—the numerical rating assigned to the child for a given objective or dimension is within those of the appropriate target band; and (3) Exceeds—the numerical rating assigned to the child for a given objective or dimension is higher than those of the appropriate target band.

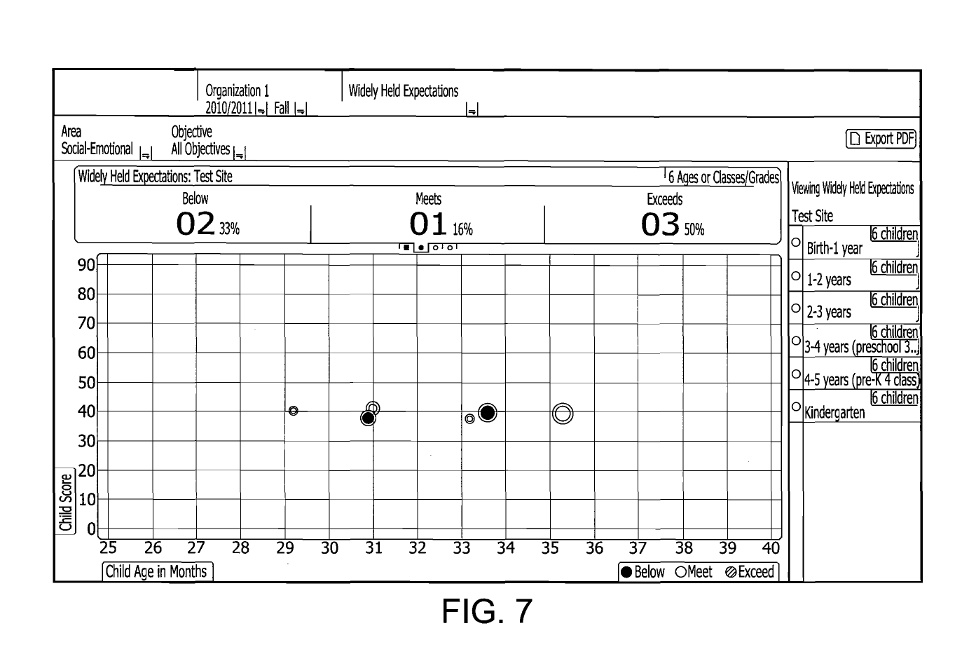

FIG. 7 is an example of a Widely Held Expectations Report. As shown in FIG. 7, a gray-shaded horizontal band on the screen represents the widely held expectations for a class. This band can correlate to the target bands for the age/class, and can have the same color or other visual representation for the desired target band. By looking at the placement of the small squares or circles on the report graph, a care giver can see where each child's or group's skill level is related to widely held expectations for an area of development, objective, or dimension. As shown in the report of FIG. 7, two children are below widely held expectations for the social-emotional area (cumulative of all objectives), 1 student meets the widely held expectations, and 3 students exceed the widely held expectations. While this report shows a class in relation to an area, Widely Held Expectation Reports can be run based on objectives, dimensions, and the like. Widely Help Expectation Reports can also be run for just one child.

Class Profile Reports provide a table listing each dimension and objective. It shows the progressions and under each level lists the names of children based on the assessment of the children's skills. This report helps care givers plan for small group experiences by quickly and visually identifying where children are with respect to a particular area, objective, or dimension. For example, if all the children in a class are in level 4 for a particular dimension, the care giver knows he/she will not have to spend time teaching level 2 skills. In the same vein, if all of the children are in level 4 for a particular dimension, the care giver knows he/she should not be teaching at level 8.

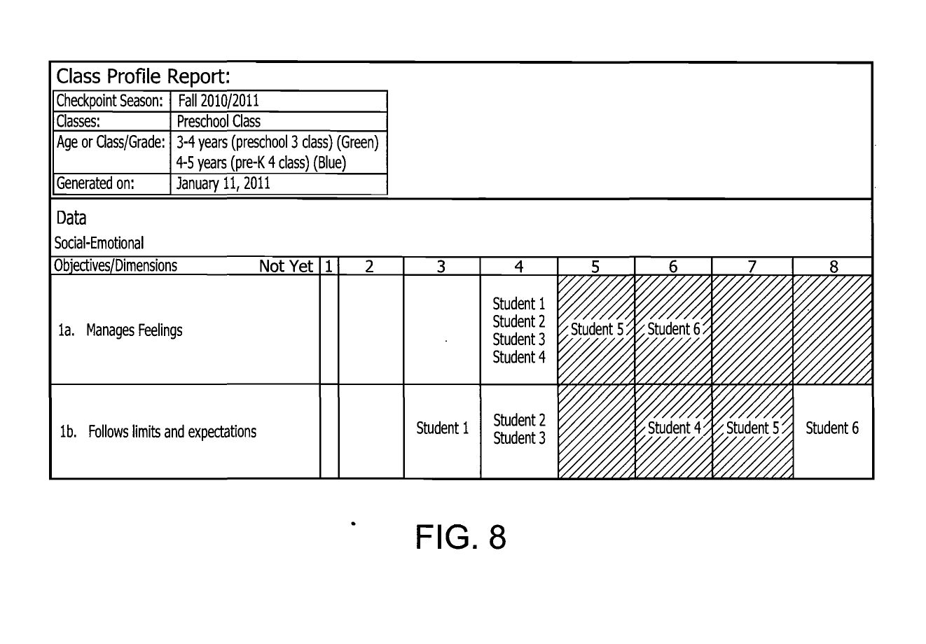

FIG. 8 is an example of a Class Profile Report. With this report, a care giver can quickly see that 4 students are below expectations (non-shaded area) for “Manages Feelings” while 2 students meet expectations (shaded area, which correlates to the target band for the children's age/class level) for that dimension. As with other reports, the shaded area can be the same color or have the same visual representation as the relevant target band. FIG. 8 also shows that three students are below expectations for “Follows limits and expectations,” two children meet expectations for that dimension and one child exceeds expectations for that dimension. While FIG. 8 shows a report for only two dimensions, the reporting module of the present invention is not so limited. The module can generate Class Profile Reports for multiple areas, multiple objections, multiple dimensions, and combinations of those. The report can have all the students in a class or a subset of that class. The report can include students from multiple classes.

Individual Child Profile Reports provide a table listing each dimension and objective. The report records and shows a care giver's checkpoint data. The report also shows the checkpoint data under the appropriate level as indicated by the care giver. It can be used for a single checkpoint or across multiple checkpoints. The report shows a child's skills in relation to widely held expectations (indicated by color shading or other visual representation that correlates to a desired target band) for an objective and/or a dimension. A comprehensive Individual Child Profile report shows a child's skill in relation to widely held expectations for each objective and dimension. The report can show the progress of a child for part of a year, for a full year or for more than one year. An Individual Child Profile Report may become part of a permanent record of a child and may be useful to pass on to a subsequent care giver.

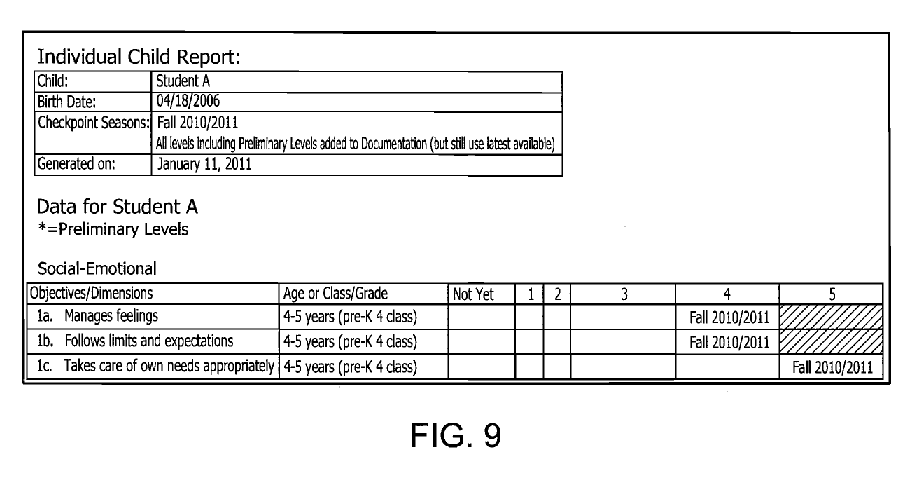

FIG. 9 is an example of a Child Profile Report. As shown, at the Fall 2010/2011 checkpoint Student A was in level 4 for both “Manages feelings” and “Follows limits and expectations,” and in level 5 for “Takes care of own needs appropriately.” Also as shown, those levels are below expectations as designated by the shaded area, which represents the target band for Student's age/class level.

The Development and Learning Report highlights a child's strengths in particular areas of development and learning (i.e., what a child is able to do in relation to selected objectives and/or dimensions), preferably along with a supporting activity. The supporting activity is preferably designed to promote the next level of growth described in the report. In generating the report, a care giver can select the child or children and the area or areas of development and learning the care giver wants to view. The selection can be made through clicking check boxes next to the item to be selected, selecting the items via drop down menus or other similar means.

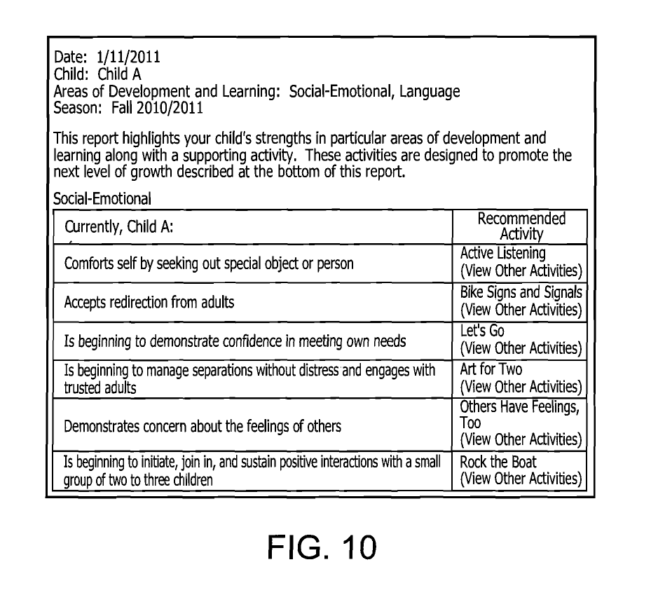

FIG. 10 is an example of a Development and Learning Report. The left column shows what the student is currently capable of achieving. The right column shows recommended next step activities. Preferably, the listing of activities are hyperlinked such that the care giver can get more information about the particular activity. As shown, there is also a hyperlink to view other activities, which may be helpful if the care giver is looking at longer range planning.

The Snapshot Reports show the scores of an individual child or group of children at one point in time, like a photograph. A care giver can generate one report to show that a child is or a group of children are below, meeting, or exceeding expectations for an area of development and learning; an objective; a dimension; or another outcome, such as a Head Start performance standard or state early learning standard. Another Snapshot Report can show each child's developmental level for only selected objectives or dimensions. Snapshot Reports enable a care giver or administrator to see at a glance the status of each child or group of children. In generating the report, the care giver preferably can select the standards and measures, the children, the demographics, and the checkpoint period to be analyzed.

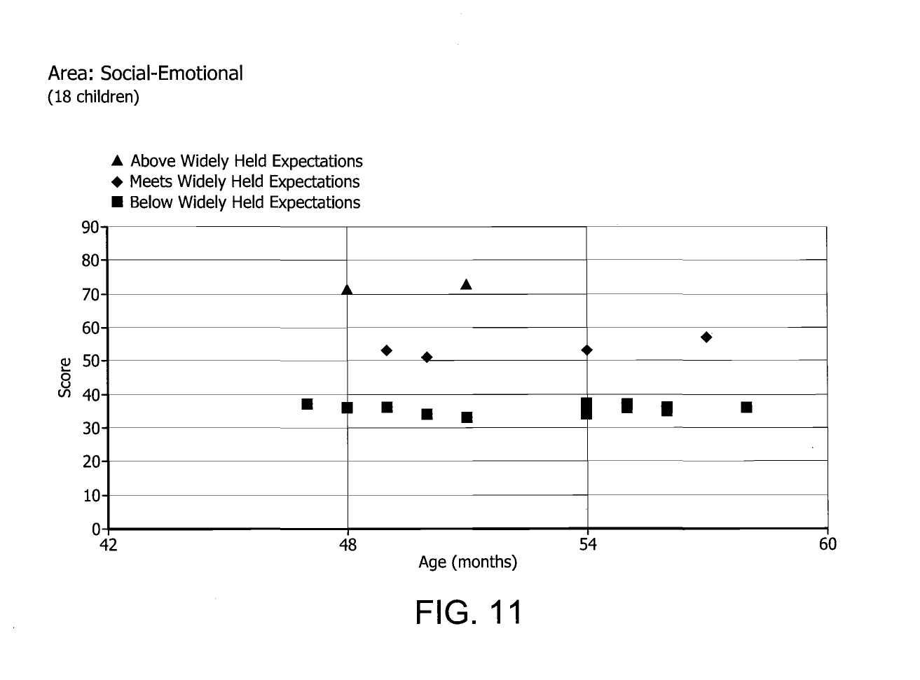

FIG. 11 is an example of a Snapshot Report. As shown, the squares represent children who are below expectations, the diamonds represent children that meet expectations, and the triangles represent children who exceed expectations. The report provides the care giver with a quick view of where the class stands with respect to a specific area, objective or dimension, and provides the scores of the children so the care giver can see how close (or far) each of the children that are below expectations are from meeting expectations.

The reports help care givers understand how best to support children. The reports, in the various forms, highlight strengths and weakness and allow a care giver to explore additional information, were necessary, such as considering whether a child is younger or older than most of the children in the group or grade, whether the child recently entered the program or school, whether the child has a disability, or whether there are family or language issues to explore.

The reporting module can also create reports that allow the care giver to use the information in the system to develop reports that correspond to requirements of local, state or federal programs and/or other education programs such as Head Start. The information in the reports can be based on the state standards or Head Start alignment selected by the user. The user can also choose to look at the skills, knowledge, and skills of individual children or of a group of children.

In the report each requirement (e.g., local, state, federal, or Head Start) can be displayed with a corresponding objective/dimension(s) of the present system shown with it or in close proximity to it. For Alignment Reports the user clicks on a standard or other objective and the system shows the target score for the widely held expectations of the present system that aligns with the expectations (e.g., state's expectations) for the relevant age/class year (e.g., end of Pre-K). The Alignment Report can show whether the child's or children's skills are “emerging” toward meeting expectations (e.g., state's expectations) or whether the child's or children's skills show that the skills are “accomplished.”

For Head Start Alignment Reports the user clicks on a Head Start standard or other objective and the system shows the target score for GOLD that aligns with Head Start expectations for the relevant age/class year (e.g., end of the preschool 3 year or pre-K 4 year). The Head Start Alignment Report can show whether the child's or children's skills are “emerging” toward meeting Head Start expectations or whether the child's or children's skills show that the skills are “accomplished.”

In many situations, more than one care giver can provide documentation on a child at one or more locations. For example, a teacher may assess child A at school, a physical therapist may provide documentation and associated assessment of child A's skills, behavior, and knowledge at a physical therapy center, and a nurse may do the same at child A's home. Input from each of these care givers is important in the effort to accurately assess the child's skills, behavior and knowledge. One care giver may pick up what the other two care givers may have missed. For example, the physical therapist may see child A exhibit gross motor skills that neither the nurse nor the teacher had seen. In addition, certain care givers are in a position to better assess certain objectives. For example, a teacher is in a better position to assess a child's interaction with other children, while a nurse working in the child's home may be in a better position to assess a child's interaction with the child's parents.

To provide an accurate assessment involving multiple care givers, a system of the present invention includes mechanisms that allow multiple care givers to provide input on the same child, e.g., child A, from multiple locations, e.g., school, physical therapy center, and home through the internet. Each care giver would be provided with a unique username and password in order to log onto the system. When the care giver logs on, information would be accessible on each child for which the care giver is providing care. For example, a teacher would have access to information on all of the children in his/her class; a physical therapist would have access to information on all of the children he/she is treating; and so on. So, the teacher could have access to information for children A through G, while the physical therapist has access to child A, child M, and child X. Where commonalities occur (e.g., child A), both the teacher and the physical therapist would be capable of reviewing and updating the child's information.

In a multi-care giver set up, preferably, one care giver is the final arbiter of how the child should be scored on all of the objectives. As used herein, that one care giver is termed the “evaluator” or “case manager”. The evaluator or case manager preferably has more rights in the system than the other care givers. The other care givers can add comments about the child to the system and can suggest to what area, objective, dimension, or indicator those comments should apply. The comments can appear in the system in chronological order or can be organized by who made the comment, what area, objective, dimension, or indicator the comment pertained, and the like. The other care givers can also print reports for each of the children to which they have been “invited” to comment. As used herein, “invited” means to be provided access to the information regarding a child or children. A person can be invited with read only access, read/write access, etc. A person can be invited with full access (i.e., ability to view and/or edit all fields), or limited access.

The evaluator preferably has the same access as the other care givers, but it also has the ability to rearrange to what area, objective, dimension, or indicator the comments entered by the other care givers should apply and also has the ability to adjust level designations made by a care giver for any dimension. Preferably, the evaluator does not have the ability to edit and/or delete the comments made by other care givers.

In addition to providing comments directly about the child, the system preferably allows the multiple care givers to communicate with each other. The communication can be directed to all care givers, to all care givers and the parents or guardians, to the parents or guardians, to select care givers, to select care givers and the parents or guardians, and so on. The communication can be by way of notes posted on the system, e-mails, instant messaging, audio files, video files, or other similar communication methods.

Preferably, each of the care givers (or single care giver if there is only one) uploads his/her comments directly onto the system via a computer connected to the internet, a computer connected directly to a server housing the database system, or other similar set ups. However, it is within the scope of the invention for a care giver to take notes, etc. on a personal digital assistant, a cellular phone, or other similar device. Those notes can then be uploaded onto the system by way of typical data transfers. In this way, a care giver can observe a child and take notes in real-time without having to write the notes on paper and/or sit at a computer while observing the child.

One feature of the system is the ability of care givers to view data and reports for a particular child at any time. Hence, a parent who is away from home, such as a parent in the military, can log into the system and see the development of a child located distant from the parent. The ability to include pictures and drawings (through known scanning techniques) and/or audio and video files allows the parent to visual representations of the child's skills, behavior, and knowledge. Thus the system provides parents and care givers with a unique portal into a child's development.

The methods and systems of the present invention include collecting developmental assessment data, which primarily comprises observational assessment data, and converting that data into an overall assessment of a child in a particular area, objective, dimension, or indicator, and providing reports detailing that assessment. The methods and systems are done by automation. As a result, a teacher can simply make observations about a child in their normal course of business. Those observations can then be inputted in the methods and systems of the present invention and, through an automated system, a report meeting local, state, etc. requirements can be generated based in part on that information. The present invention provides a novel system for converting observational assessment data into predetermined areas, objectives, dimensions, and indicators.

The system will allow the care giver to sort the children to which it has access in any number of ways. The children can be sorted by name, age, developmental level, geographic area, common care givers, and so on. The care giver can then input information into the system for a particular child as described above.

The systems described above may be configured as a computing application, a computing applet, a computing program and/or other instruction set operative on a computing system to perform the functions, operations, and/or procedures described above. An exemplary computing system is controlled in a known way primarily by computer readable instructions, which may be in the form of software, for performing the various steps, processes, and functions described above. The computer readable instructions can contain instructions for the computing system for storing and accessing the computer readable instructions themselves. Such software may be executed within one or more processing units, such as a microprocessor, to cause the computing system to do work.

The present invention may be implemented in a variety of computer environments (including both non-wireless and wireless computer environments), partial computing environments, and real world environments. The various techniques described herein may be implemented in hardware or software, or a combination of both. Preferably, the techniques are implemented in computing environments using programmable computers that include a processor, a storage medium readable by the processor (including volatile and non-volatile memory and/or storage elements), at least one input device, and at least one output device. Each such computer program is preferably stored on a storage medium or device (e.g., ROM, flash memory, or magnetic disk) that is readable by a general or special purpose programmable computer for configuring and operating the computer when the storage medium or device is read by the computer to perform the procedures described above. The apparatus may also be considered to be implemented as a computer-readable storage medium, configured with a computer program, where the storage medium so configured causes a computer to operate in a specific and predefined manner.

As noted above and set forth in the claims below, the developmental assessment data used in the present invention is primarily gathered through observation based on widely held developmental and learning milestones unlike conventional systems that typically use tests to assess development of a child's skills, knowledge, and behavior. The system and methods set forth above are designed to provide a high quality assessment of the data by taking multiple pieces of data to assess skill sets and visually comparing that information against widely held expectations for various stages of life. Other conventional algorithms and analyses may be used. The claimed invention is not limited to any specific algorithm or analysis for converting observational data to assessments of areas or objectives.

It will be appreciated by those skilled in the art, that the present invention may be practiced in various alternate forms and configurations. The previously detailed description of the disclosed embodiments is presented for purposes of clarity of understanding only, and no unnecessary limitations should be implied there from. For example, while the preferred embodiment uses the terms area, objectives, dimensions, indicators, examples, progressions, and levels, it is understood that one or more of the following can be used synonymously with one or more of the concepts of the present invention: goals, domains, domain elements, standards, early learning standards, early learning framework, concepts, strands, developmental learning strands, benchmarks, performance indicators, learning opportunities, performance expectations, continuum, continua, learning outcomes, outcomes, “Desired Results Developmental Profile,” grade level expectations, evidence outcomes, skill areas, early learning guidelines, foundations and Skills, and sub domains.

We claim:

1. A method for evaluating a child's skills with a computer implemented system including at least one database, the method comprising the steps of:
assigning in the system a level to a first dimension in a first objective based on observational assessment data for a first child;
repeating the assigning of levels for additional dimensions in the first objective for the first child;
compiling the value for each dimension in the first objective to achieve a recommended objective assessment value for the first objective;
using the system to compare the recommended objective assessment value to a predetermined target band stored in the database to assess the child in the first objective, wherein the target band comprises a range of widely held expectations for a child that is the same age or in the same grade as the first child.

2. The method of claim 1, wherein the observational assessment data is based on an assessment of one or more of scanned images, video clips, audio clips, text, drawings, and photographs.

3. The method of claim 1, wherein the method further includes assigning in the system a level to a dimension in one or more additional objectives based on observational assessment data for the first child, the method further comprising:
repeating the assigning of levels for additional dimensions in the one or more additional objectives;
compiling the value for each dimension in the one or more additional objectives to achieve objective assessment values; and
using the system to compare the objective assessment values to predetermined target bands stored in the database to assess the child in the one or more additional objectives.

4. The method of claim 3, wherein the method further comprises using the system to compile objective assessment values for objectives relating to a first area to a achieve an first area assessment value, and comparing the first area assessment value to a predetermined target band stored in the database to assess to the child in the first area.

5. The method of claim 1, wherein predetermined target bands are based on an age range selected from the group consisting of birth to one year, one to two years, two to three years, three to four years, four to five years, and kindergarten.

6. A computer implemented system for evaluating development of a child comprising:
a secure database for storing information related to a child, the information including information related to the development of the child, the database comprising a hierarchal structure comprising objectives and dimensions;
program code configured to allow entry into the database at an initial checkpoint of observational assessment data about the child relating to dimensions and to allow modification of the observational assessment data at a final checkpoint;
program code configured to compile the observational assessment data at the final checkpoint to achieve at least one summary value for the child;
program code configured to compile the at least one summary value for an objective and run a comparison of the at least one summary value with predetermined target bands stored in the database to assess the child in one or more of an objective; and
a reporting module configured to produce report showing the at least one summary value in relation to the predetermined target bands.

7. The system of claim 6, wherein the predetermined target bands are based on an age range selected from the group consisting of birth to one year, one to two years, two to three years, three to four years, four to five years, and kindergarten.

8. The system of claim 6, wherein the program code configured to allow entry into the database at an initial checkpoint of observational assessment data about the child relating to dimensions comprises coding to permit uploading the information onto the system via a computing device connected to the interne.

9. The system of claim 8 wherein the computing device comprises one or more of a personal computer, a personal digital assistant, and a phone.

10. The system of claim 6, wherein the predetermined target bands relate to typical development in the objective.

11. The system of claim 6, wherein compiling comprises scaling the observational assessment data based on predetermined weighting criteria stored in the database.

12. A computer program product comprising a computer storage medium having program logic stored thereon, the program logic comprising machine readable code executable by a computer, the machine readable code programmed to perform the steps of:
assigning in the system a level to a first dimension in a first objective based on observational assessment data for a first child;
repeating the assigning of levels for additional dimensions in the first objective for the first child;
scaling each of the levels based on predetermined weighting criteria in the system to achieve a scaled value for each dimension;
compiling the scaled value for each dimension in the first objective to achieve an objective assessment value for the first objective;
providing an output comparing the objective assessment value to a predetermined target band stored in the database to assess the child in the first objective.

13. The product of claim 12, wherein the predetermined target bands are based on an age range selected from the group consisting of birth to one year, one to two years, two to three years, three to four years, four to five years, and kindergarten.
